(19) United States
(12) Patent Application Publication
(10) Pub. No.: US 2016/0367840 A1
(43) Pub. Date: Dec. 22, 2016

(54) CLAMPING DEVICE FOR A ROPE

(71) Applicant: OBERALP SPA, Bozen (IT)

(72) Inventor: Egon Resch, Tiers (IT)

(21) Appl. No.: 15/184,274

(22) Filed: Jun. 16, 2016

(30) Foreign Application Priority Data
Jun. 18, 2015 (DE) 102015211254.3

(51) Int. Cl. A62B 1/08

(52) U.S. Cl. CPC A62B 1/08

(57) ABSTRACT

The invention provides a clamping device for a rope, comprising: a first wall portion (116) and a second wall portion opposite the first wall portion, characterised in that the first wall portion (116) has a surface configuration which is set up to move the rope into a clamping region (114) of the clamping device in the event of movement within the clamping device in a first axial rope movement direction and which is set up to move the rope into the clamping region (114) of the clamping device in the event of movement within the clamping device in a second axial rope movement direction counter to the first axial rope movement direction.

The present invention relates to a clamping device for a rope, which can be used in particular in the field of climbing.

In many fields, it is necessary to transmit the movement of a rope to another element. In this context, it is conceivable in particular to suspend a load on a rope during climbing using an ascender or to clamp a rope on a pivotable element, for example a rope pulley which has been locked within a safety device so as to clamp a rope.

In many cases, clamping devices of this type have the problem that the rope is not guided securely and reliably in the clamping region and/or that clamping cannot be provided independently of a rope pull direction.

The object of the present invention is therefore that of providing a clamping device for a rope and/or a handling device for a rope which has a clamping device according to the invention that provides particularly secure clamping of the rope.

A first aspect of the invention provides a clamping device for a rope, comprising a first wall portion and a second wall portion opposite the first wall portion, the first wall portion having a surface configuration which is set up to move the rope into a clamping region of the clamping device in the event of movement within the clamping device in a first axial rope movement direction and which is set up to move the rope into the clamping region of the clamping device in the event of movement within the clamping device in a second axial rope movement direction counter to the first axial rope movement direction. As a result of the surface configuration, in the event of a relative movement of the rope with respect to the clamping device, the rope is moved into a clamping region, and as a result clamping of the rope in the clamping device can be achieved securely and reliably independently of the axial rope movement direction of the pull on the rope. The movement into the clamping region is preferably transverse to the first and/or second axial rope movement direction, at least locally.

A second aspect o the invention, which can be combined with the first aspect of the invention, provides a clamping device for a rope, comprising: a first wall portion and a second wall portion opposite the first wall portion, characterised in that the first wall portion has a surface configuration which has a transport element, the rope and a contact portion of the transport element being at a crossing angle which is in angle range between 15° and 75°, preferably in an angle range between 30° and 60°, in particular at approximately 45°, when the rope is laid in the clamping device as in normal operation. In particular, the crossing angle may be constant over the contact portion or the transport element. The inventor of the clamping device has found that, for a crossing angle in the range between 15° and 75°, the rope is moved into a desired region of the clamping device, such as a clamping region, after a particularly short phase of a rope movement; if the crossing angle is in a range between 30° and 60°, this further results in a favourable compromise between the length of the required rope movement to move the rope into the desired region and a clamping effect brought about by the contact portion of the transport portion. The optimum for this comprise was achieved at a crossing angle of approximately 45°. In particular, a constant crossing angle along the contact portion or the transport element makes it possible for the shape of the contact portion or of the transport element to be optimisable for a desired function, for example a clamping function or a transport function.

The following preferred embodiments may relate to both aspects of the invention. If feature denotations from an above-mentioned aspect or an above embodiment are repeated in the description, they may relate in particular to the feature of this aspect or embodiment, but this is not compulsory.

The second wall portion may be formed like the first wall portion so as to reinforce the function, such as clamping and/or transportation, of the first wall portion by way of a counter piece.

It is possible for an axial rope movement direction to be transverse to a rope clamping direction when the rope is laid in the clamping device as in normal operation. Two directions are transverse to one another in particular if they are at an angle between 45° and 90°, preferably between 60′ and 90°, more preferably of approximately 90°. Likewise, a/the rope clamping direction may be transverse to the rope propulsion direction. If these two directions are transverse to one another, there is little interaction between the functions defining the directions, and the elements on which the functions are based can be optimised substantially without taking this interaction into account. This effect can be observed starting from an intermediate angle in the range between 45° and 90°, is reinforced in the range between 60° and 90°, and can be observed most strongly at an intermediate angle of approximately 90°.

In the clamping direction for a rope, the surface configuration may have at least one transport element which is formed as a rib and preferably projects into a clamping region. A rib makes it possible to engage in the rope even in the event of a low pressure of the rope on the first wall portion of the rib, in order to securely and reliably provide a transport function and/or a clamping function for the rope. If the rib protrudes into the clamping region, it performs both a transport and a clamping function, which assists clamping in a clamping region. Alternatively, the transport element may be configured as a structure which protrudes into the first wall portion and which can protrude into the clamping region and thus perform a dual function analogous to the above-described dual function. A structure of this type can be milled from a blank by removing a small amount of material, it thus being possible to manufacture clamping devices adapted to specific requirements cost-effectively from a single type of blank.

The surface configuration of the clamping device may have a pair of transport portions comprising a first transport portion which is set up to move the rope into a first clamping region portion of the clamping device in the event of movement within the clamping device in a first axial rope movement direction and a second transport portion which is set up to move the rope into a second clamping region portion of the clamping device in the event of movement within the clamping device in a second axial rope movement direction counter to the first axial rope movement direction. In this context, each of the first transport portion and the second transport portion can be optimised for particularly rapid transport of the rope with respect to the respective clamping region portion. Further, the first transport portion may have one or more transport elements, a contact portion of one transport element, preferably all transport elements, of the first transport portion in each case being at a first crossing angle to a rope laid in the clamping device as in normal operation, each crossing angle having a first sign, and the second transport portion may have one or more transport elements, a contact portion of one transport element, preferably all transport elements, of the second transport portion in each case being at a crossing angle to a rope laid in the clamping device as in normal operation, each crossing angle having a second sign different from the first sign. This configuration allows, to a certain extent, secure and reliable transport of the rope with respect to the respective clamping region portion. The first transport portion can be directly adjacent to the second transport portion in the axial rope movement direction, meaning that the surface of the surface configuration is used particularly efficiently for rope transport. Clamping region portions may be part of a clamping region.

The clamping device may be in the form of a pivot element, preferably a rotation element, more preferably a rope pulley. As a result, the clamping device is particularly suitable for performing a rotational or pivoting movement, in particular within a handling device for a rope, it being possible to couple this movement into a reliable securing mechanism, such as a centrifugal clutch, in a particularly simple manner.

The clamping device may have a rope deflection portion, it being possible for in particular a pivot or rotation axle of the clamping device to pass through the rope deflection portion. As a result of a rope course which deviates from a straight line, caused by the rope deflection portion, tension on the rope can lead locally to a desired rope movement, for example in a rope pulley a movement towards the centre of the rope pulley. This can assist clamping of the rope at a clamping region at the centre of the rope pulley. If a pivot or rotation axle of the clamping device extends through the rope deflection portion, the clamping device, for example a rope pulley, can be formed in a particularly compact manner.

In the clamping device, the first wall portion and the second wall portion may be arranged in such a way that they delimit a tapering clamping region of the clamping device. A clamping region of this type clamps the rope securely and reliably.

The tapering clamping region may have a base portion which limits the maximum clamping force acting on the rope, in such a way that overloading of the rope can be prevented. The base portion preferably forms a flattened region, in the region of the clamping portion where the first wall portion and the second wall portion meet.

Further, it is possible for wall sub-portions of the first wall portion and the second wall portion which delimit the tapering clamping region over the entire extent thereof to be formed free of ribs, preferably smooth. This also allows a (possibly additional) reduction in the maximum clamping force acting on the rope, in such a way that, in the event of excessive rope loads on a rope clamped in the clamping device, some amount of slipping of the rope can occur so as to counter the rope load.

The clamping device may be set up to transfer the rope into a clamping state without a relative movement of elements of the clamping device; in this case, the clamping device is particularly insusceptible to faults as a result of the lack of elements that are movable relative to one another.

It is conceivable to form the clamping device such that, when the rope is laid in the clamping device as in normal operation, in a clamping state, the rope is constantly in contact with the first wall portion and preferably with the second wall portion between the initial entry of the rope into the clamping device and the final exit thereof from the clamping device. This prevents the rope from being able to crush a user's finger if said rope exits the clamping device in the meantime (for example in the case of a tuber) when the rope is clamped in the clamping state in the clamping device. If the rope is additionally in contact with the second wall portion, the risk of a finger injury is further reduced.

If a handling device for a rope, in particular a safety device for a rope, comprises one of the above-described clamping devices, the aforementioned advantages are transferred to the handling device or safety device.

If the clamping device of the handling device for a rope is the above-described clamping device, the surface configuration of which has a pair of transport portions, the first transport portion can be separated from the second transport portion by a boundary portion and, in a state where the rope is clamped in the clamping device, the boundary portion and a rope pull direction may be at an angle between 90° and 60°, preferably between 85° and 75°, more preferably between 83° and 82°. In a state where the rope is clamped in the clamping device, the clamping device is, at least sometimes, preferably locked in terms of the movement thereof in the handling device. The inventor has found that there is a favourable clamping effect within the handling device when the rope is clamped in the clamping device, if the boundary portion and a rope pull direction are at an angle between 90° and 60°. A significant improvement in the clamping effect has been found when this angle is between 85° and 75°, an optimum for the clamping angle being set at an angle between 83° and 82°, according to the inventor's tests.

In the following, the present invention is described with reference to the accompanying drawings, in which:

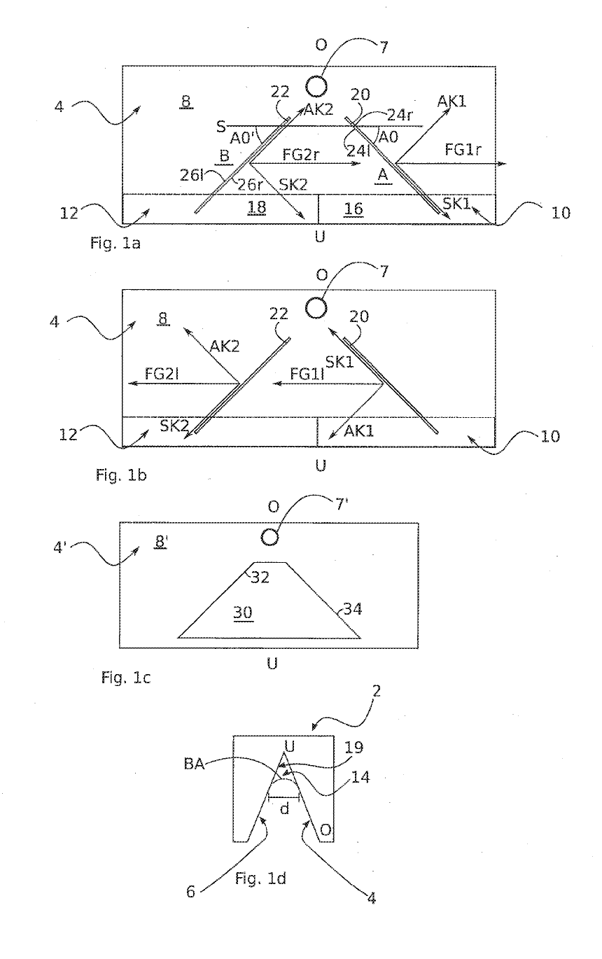

FIGS. 1a and 1b show a first wall portion of a first embodiment of a clamping device according to the invention;

FIG. 1c shows a variant of a first wall portion of the first embodiment;

FIG. 1d is a cross section of the first embodiment of a clamping device according to the invention;

FIGS. 1e to 1g show extensions of transport elements and/or contact portions;

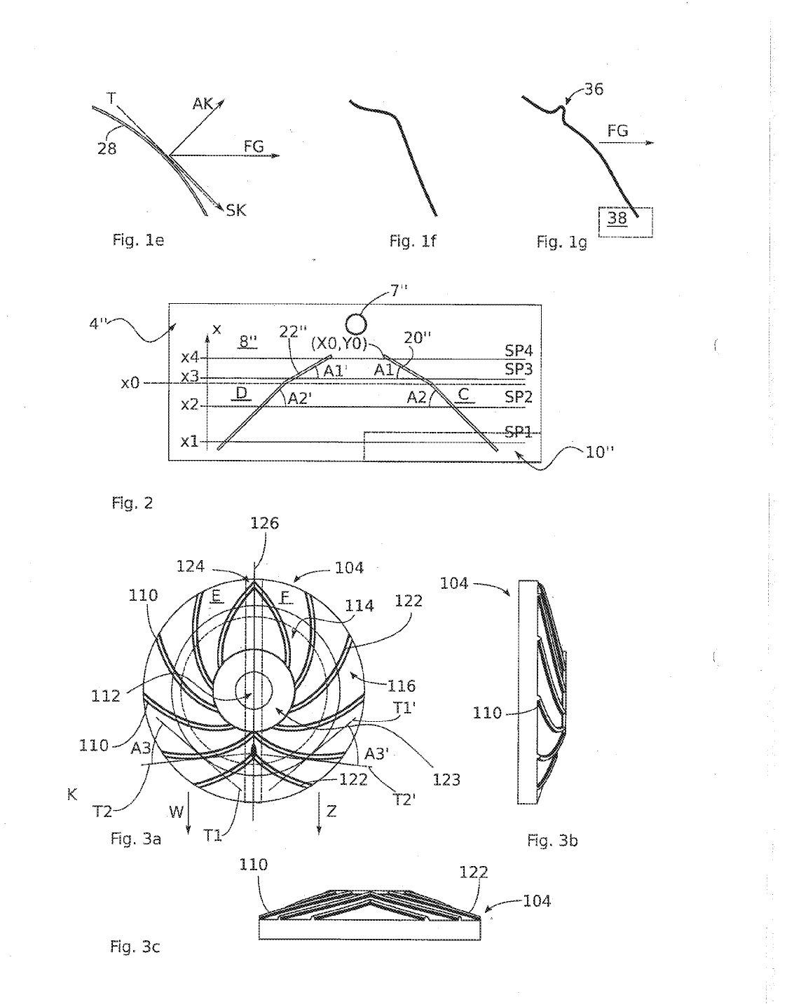

FIG. 2 shows a variant of a first wall portion of the first embodiment;

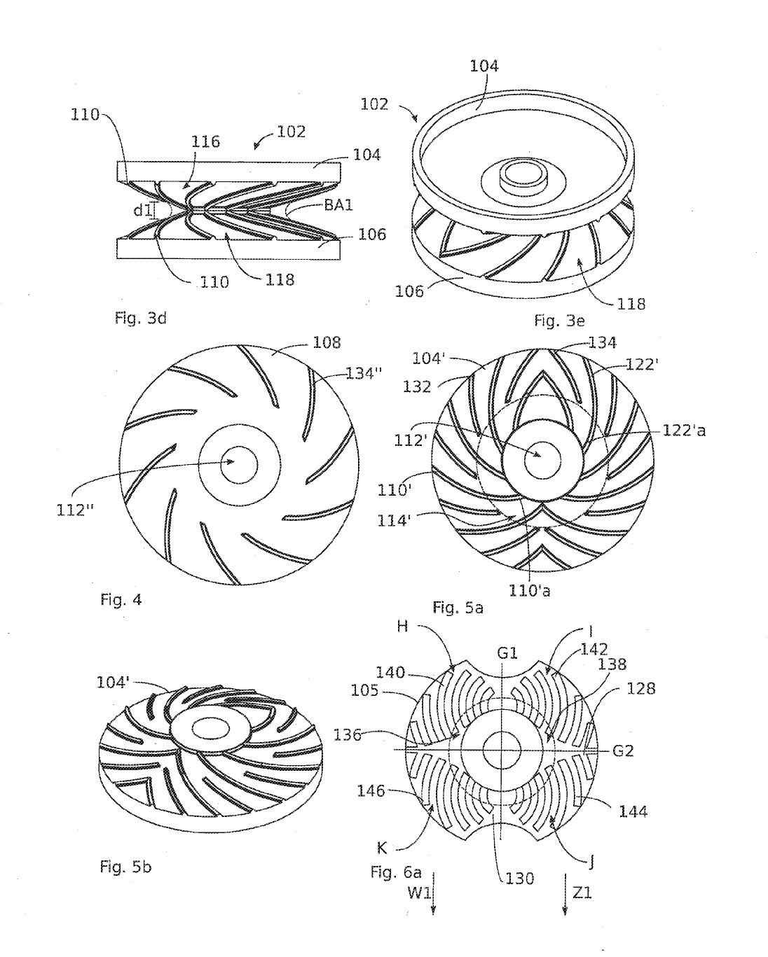

FIGS. 3a and 3c are views of rope pulley halves of a second embodiment of a clamping device according to the invention;

FIGS. 3d and 3e are views of rope pulleys of the second embodiment of the clamping device according to the invention;

FIG. 4 shows a first variant of a first wall portion of the second embodiment;

FIGS. 5a and 5b are views of a second variant of a first wall portion o he second embodiment;

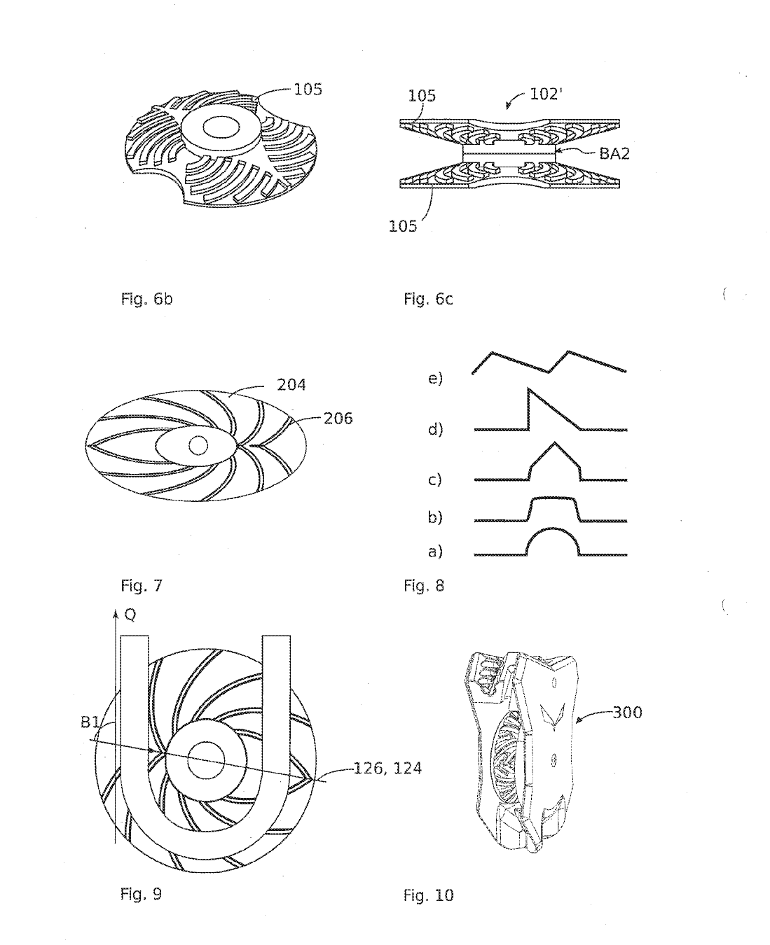

FIGS. 6a and 6b are views of a third variant of a first wall portion of the second embodiment;

FIG. 6c shows a variant of the clamping device of the second embodiment;

FIG. 7 shows one half of a rope clamping body of a further embodiment of a clamping device according to the invention;

FIG. 8 a) to e) show structures of transport elements;

FIG. 9 is an internal view of a rope pulley of the second embodiment having an inserted rope in the clamped state;

FIG. 10 shows a safety device comprising a rope pulley of the second embodiment.

In the following, in variants of embodiments, like elements are provided with like reference numerals where expedient.

### First Embodiment of the Invention

FIG. 1d is a schematic cross section through a groove-shaped clamping device 2 for a rope, comprising a first wall portion 4 and an opposite second wall portion 6. For receiving a carabiner, the clamping device 2 may have an opening 7 (or 7′ or 7″), which is shown only in the surface configurations of FIGS. 1a to 1c and 2. The first wall portion 4 comprises a surface configuration 8 which is set up to move the rope into a first clamping region portion 10 of the clamping device 2 when a rope moves in a first axial rope movement direction (in the direction FG1r or FG2r) and to move the rope into a second clamping region portion 12 when the rope moves in a second axial rope movement direction (in the direction FG2l or FG1l) counter to the first axial rope movement direction. The clamping region portions 10 and 12, the delimitation of which by the first wall portion 4 in FIG. 1a is shown by dashed lines in FIG. 1a, are part of a clamping region 14 of the clamping device 2. An axial rope movement direction follows in particular the rope course.

The first wall portion 8 is arranged in the clamping device 2 in accordance with the orientation U-O (cf. FIG. 1d), and so the first clamping region portion 10 is delimited and defined by a first wall sub-portion 16 of the first wall portion 4 and an opposite portion of the second wall portion; analogously, a second wall sub-portion 18 of the first wall portion 4 together with an opposite portion 19 of the second wall portion 6 delimits and defines the second clamping region portion 12. As an alternative to what is shown in FIGS. 1a and 1b, the wall sub-portions 16 and 18 may be formed free of ribs. The portion 19 of the second wall portion 6 may also be formed free of ribs, in such a way that these wall sub-portions, which delimit the tapering clamping region 14 over the entire extension thereof, are formed free of ribs. This makes it possible to reduce the clamping force acting on the rope. It should be noted that, when clamped, the rope can be both in contact with the rib-free wall sub-portions, which delimit the clamping region over the entire extension thereof, and in contact with a region of the clamping device provided with ribs. The clamping region 14 shown in FIG. 1d may, as indicated by the dashed line in FIG. 1d, comprise a base portion BA which forms a flattened region with respect to a V-shape in the region in which the first wall portion meets the second wall portion. As a result of the base portion BA, the clamping forces acting on the rope can be reduced. It is preferred for the base portion BA to be of a width d of approximately 2 mm or more. Generally, providing a base portion in a clamping region can be combined with providing rib-free wall sub-portions which delimit the clamping region over the entire extension thereof.

Generally, a rope within the clamping device can be described by a rope path which defines a rope position, in particular if the rope is laid in the clamping device as in normal operation, for example by an orthogonal projection of the rope centre onto the first wall portion or by a rope contact face, which corresponds with the rope course, together with the first wall portion or the like. Angles to the rope, in particular crossing angles, can accordingly be interpreted as angles to the relevant rope path. The rope can be moved along this rope path in a first axial rope movement direction and an opposite second axial rope movement direction.

Preferably, the surface configuration 8 has a first transport portion A, which has at least one first transport element 20, for example formed as a rib or recess, and also preferably the surface configuration 8 comprises a second transport portion B, which has at least one second transport element 22, for example formed as a rib or recess. Preferably, by means of the first transport element 20, the surface configuration 8 is set up to move the rope into the clamping region 14 in the event of movement within the clamping device 2 in the first axial rope movement direction. Accordingly, by means of the second transport element 22, the surface configuration 8 can be set up to move the rope into the clamping region 14 in the event of movement within the clamping device 2 in the second axial rope movement direction. In FIGS. 1a and 1b, a rope path may extend along the arrows FG2r and FG1r or FG2l and FG1l, and in this case the first axial rope movement direction corresponds to the direction of FG1r or FG2r and the second axial rope movement direction corresponds to the direction of FG1l or FG2l. If a rope is moved in the first axial rope movement direction while in contact with the surface configuration 8, it being assumed that the transport elements 20, 22 are formed as ribs, the left-hand edge 24l of the rib 20 engages against the rope, and the engagement force FG1r thus produced, as part of a tensile force on the rope, is split into a component SK1 (rope propulsion force SK1 in rope propulsion direction) parallel to the rib 20 and a component AK1 (pressure in pressure direction) perpendicular to the rib 20, and so the vector sum of the components SK1 and AK1 is FG1r. The rope propulsion force SK1 points in the direction of the first clamping region portion 10, and moves the rope into the clamping region 14, and in particular into the first clamping region portion 10, in the case of the first axial rope movement direction.

The first transport portion A thus moves the rope into the clamping region 14, and preferably into the first clamping region portion 10, if the first axial rope movement direction applies.

Analogously, the left-hand edge 26l of the rib 22 engages against the rope and the engagement force FG2r is split into a pressure AK2 and a rope propulsion force SK2, the rope propulsion force SK2 moving the rope in a rope propulsion direction pointing away from the second clamping region portion 12.

FIG. 1b shows the corresponding situation for the second axial rope movement direction, the engagement forces FG2l, FG1l being produced correspondingly by the rope engaging against the right-hand edges 24r, 26r of the ribs 20 and 22. In this case, the rope propulsion force SK2 points in the direction of the second clamping region portion 12 and moves the rope into the clamping region 14, in particular into the second clamping region portion 12. The second transport portion B moves the rope into the clamping region 14, and preferably into the second clamping region portion 12, if the second axial rope movement direction applies. The transport portions A and B directly adjacent in the axial rope movement direction (the transport portions A and B directly adjacent in the first and/or second axial rope movement direction) form a pair of transport portions.

The rib 20 is at a crossing angle A0 to a rope laid in the clamping device as in normal operation, the course of which rope is indicated by a straight line S, and the rib 22″ is at a crossing angle A0′ to this rope. The crossing angle A0 has a positive sign, meaning that the rib 20, or more generally a straight line/tangent which represents an extension of a contact portion of a transport element which is formed as a rib 20 in this case, has to be rotated anti-clockwise so as to sweep the crossing angle A0 as rapidly as possible. The crossing angle A0′ has a negative sign, meaning that the rib 22, or more generally a straight line/tangent which represents an extension of a contact portion of a transport element which is formed as a rib 22 in this case, has to be rotated clockwise so as to sweep the crossing angle A0′ as rapidly as possible. By this definition, crossing angles are always less than or equal to 90°, it being possible to exclude the angle of 90°, and the sign of crossing angles is preferably determined as seen in a view onto the surface configuration.

The edges 24l, 24r and 26l, 26r of the ribs 20 and 22 may be in contact with the rope and may accordingly be referred to as contact portions of transport elements. An engagement force of the rope may occur at the contact portions. The contact portions and/or the transport elements, in particular the edges 24l, 24r and 26l, 26r and/or ribs 20, 22, may be at a crossing angle between 15° and 75°, preferably between 30′ and 60°, more preferably a crossing angle of approximately 45°, to a rope laid in the clamping device as in normal operation. It has been found to he particularly advantageous for the crossing angle between a rope and the contact portion and/or transport element to be kept constant over the portions thereof, and so portions of this type can be formed for a particular function, such as threading the rope in at shallow crossing angles or a transport function and/or clamping function at steeper crossing angles. The transport elements 20, 22 may protrude into the clamping region 14, in particular into the respective clamping region portions 10, 12. It should be noted that, in the clamping device 2, the rope is clamped as a result of the movement of the rope and no relative movement of elements of the clamping device is required for this purpose.

FIG. 1c shows an embodiment of the invention similar to FIG. 1a in which a planar configuration 8′ is formed by a recess 30 having inclined edges 32 and 34 as transport elements, which also simultaneously form the contact portions of the transport elements.

It should be noted that transport elements 28, as shown in FIG. 1e as a rib, and/or the contact portions thereof may also have a curved shape, in which case, to clarify the effect of the transport element or the contact portion thereof, analogously to the procedure described for FIGS. 1a and 1b, the engagement force FG is split into a rope propulsion force SK parallel to and a pressure AK perpendicular to a tangent T of the transport element 28 at a crossing point of a rope path with the transport element 28 or the contact portion thereof.

Contact portions of transport elements or transport elements themselves may, as shown in FIGS. 1e to 1g, have a plurality of forms, a configuration as in FIG. 1g not being preferred, since in the region 36 the rope propulsion direction would point away from a clamping region portion 38 in the event of an axial rope movement direction in the direction FG, whilst in the majority of contact portion/transport elements having this shape, said rope propulsion direction points in the direction of the clamping region portion 38 in the event of this axial rope movement direction.

It should be noted that the rope, when it is laid in the clamping device 2 as in normal operation (in this case parallel to FG1r or FG1l) and passes into a clamping state, in particular is thus moved into the clamping region 14, is continuously in contact with the first wall portion 4, and preferably with the second wall portion 6, between the first point at which it enters the clamping device (initial entry, corresponding for example to the left-hand side of the first wall portion 4 of the clamping device 2 in FIG. 1a) and the last point at which it exits the clamping device 2 (final exit, corresponding for example to the right-hand side of the first wall portion 4 of the clamping device 2 in FIG. 1a). Unlike tubers or similar systems, the rope remains securely within the clamping device 2 and thus protects the user of the clamping device 2 from being crushed by the rope.

If a rope, laid in the clamping device 2 as in normal operation, is clamped in the clamping region 14, a clamping force pointing away from the first wall portion 4 acts on the rope, defining a rope clamping direction, and a further clamping force, pointing away from the second wall portion 6, acts on the rope, in turn defining a further rope clamping direction. These rope clamping directions are preferably, at least locally, in each case transverse to the first and second axial rope movement direction, and may in each case be orientated perpendicularly to the respective first or second wall portion 4 or 6.

The configuration of a transport element and/or the contact portion thereof (a configuration of a contact portion not being explicitly discussed since it is analogous to the configuration of a transport element) may be based on the following consideration. If portions of a transport element comprising a rope are to be at a predetermined crossing angle, or if this crossing angle is to have a particular course, a point P which moves along the transport element will always move in a direction which is at the desired crossing angle to the rope. If it is found that the speed of the point is constant, the extension of the transport element is the path of a solution to a differential equation, the derivative of which is this speed. This differential equation can be constructed as follows.

In a first step, it is unambiguously established how desired rope paths are to extend along the surface configuration within the clamping device (they may deviate from the actual rope paths; see second embodiment). They may, as shown for example in FIG. 2, be straight lines having a constant X component (straight lines SP1 to SP4 having a constant X component x1 to x4 are shown as a sample). This results in a set of rope paths, which covers the entire surface configuration in such a way that a point on the surface configuration 8″ of the first wall portion 4″ belongs to exactly one rope path in the set of rope paths. Further, a shared first axial rope movement direction and an opposite shared second axial rope movement direction are established for the entire set of rope paths. In FIG. 2, the first shared axial rope movement direction should be to the right and the second shared axial rope movement direction should be to the left. For shared axial rope movement directions, it should be ensured that for adjacent rope paths the first axial rope movement directions substantially are not counter to one another.

In the second step, it is established in what direction the transport element should extend, and thus in which direction the rope propulsion direction should be, relative to the associated rope path for an axial rope movement direction at each point. This defines a directional field, which points in the desired rope propulsion direction at each point and thus defines the desired crossing angle. If the directional field is defined at each point as a vector field having a uniform amplitude, a velocity field is defined, which is precisely the derivative of the movement of the aforementioned point P.

In FIG. 2, for example for the first axial rope movement direction, for x>0 the rope propulsion direction should be at the crossing angle A1 with respect to the rope paths, and point downwards in the direction of the first clamping region portion 10″. For the region x≦x0, the rope propulsion direction should be at the crossing angle A2 with respect to the rope paths and point downwards with respect to the clamping region portion 10″.

From the point (X0, Y0), of an initial condition of the differential equation, a rib 20″ follows, in portions, the solution to the differential equation defined by the velocity field. If the velocity field has a discontinuity, for example at x=x0, one solution is used as far as the discontinuity and, if necessary, a different solution having corresponding new initial conditions is used, starting at the discontinuity, as is conventional when using differential equations, and so a continuous overall solution preferably results.

A corresponding vector field can be defined for the second axial rope movement direction, and a rib 22″ then accordingly follows a solution to the resulting differential equation. Individual transport elements and/or the contact portions thereof can thus each follow paths of solutions to different differential equations.

Either the respective regions of the ribs 20″, 22′ for x>x0 and x≦x0 themselves or the edges and/or surfaces of these regions of the ribs 20″, 22″ may be considered as contact portions of a transport element, and so these contact portions can be configured completely analogously to the configuration of the ribs 20″, 22″.

This general principle makes it possible to construct extensions as paths of solutions to differential equations, which for example extend in portions at a constant crossing angle to the rope, in particular for individual transport elements and/or individual contact portions of a transport element, even in the event of complicated rope courses in the clamping device, which are specified by a corresponding set of rope paths. In particular, for sets of rope paths of this type, for rope pulleys, concentric circles are conceivable, and for elliptically formed rope pulleys, ellipses having fixed focal points are conceivable, the primary axis of which is used as a parameter. In general, parameterised conic sections or conic section portions are conceivable as rope sets.

The differential equations can be solved numerically.

It should further be noted that crossing angles A1 and A2 of the ribs 20″ in a transport region C have a positive sign, whilst crossing angles A1′ and A2′ of the rib 22′ have a negative sign in a transport region D.

### Second Embodiment of the Invention

In the following, a second embodiment of the invention is described. The rope pulley halves 104′, 105 and 108 are constructed similarly to the rope pulley halves 104, and so in the following reference is made only to significant differences in these variants. The functions of the transport elements and contact portions of the second embodiment correspond to those of the first embodiment. Preferably, surface configurations of the rope pulley halves of a rope pulley are constructed mirror-symmetrically with respect to one another.

In the second embodiment of the invention, the clamping device according to the invention for a rope is in the form of a rope pulley 102, which is composed of two rope pulley halves 104 and 106 of the same kind. The rope pulley half 104 has a first wall portion 116, and the second rope pulley half 106 has a second, opposite wall portion 118. The first wall portion 116 has a surface configuration which is set up to move a rope into a clamping region 114 of the clamping device 102 using transport elements, for example ribs 110, in the event of movement within the clamping device 102 in a first axial rope movement direction, and which is set up to move the rope into the clamping region 114 of the clamping region 102 using transport elements, for example ribs 122, in the event of movement within the clamping device 102 in a second axial rope movement direction counter to the first axial rope movement direction. Alternatively, it is possible to use a first rope pulley half which has the aspect according to the invention of the surface configuration of the first and/or second aspect and a second rope pulley half 108 having a second wall portion which, as shown, has the aspect of the surface configuration of the second aspect of the invention. However, the second rope pulley half may also merely have the aspect of the surface configuration of the first aspect of the invention or have any desired surface configuration.

The surface configurations of the rope pulley halves 104, 106 have transport portions E and F respectively, the transport portion E having a plurality of ribs 110 which are at a constant crossing angle A3, preferably of 45°, to circles concentric about the rotation axle 112, of which only one circle K is shown. This also applies to contact portions, for example rib edges, of these ribs. The crossing angle A3, which has a negative sign, is formed by a tangent T1 to the circle K and a tangent T2 to a rib edge in this case; however, instead of a tangent to a rib edge, the direction of the rib may also be represented by a straight line representing the central extension of this rib at a suitable point.

The concentric circles in each case represent rope paths, and it should be noted that the rope usually does not enclose the entire rope pulley, but rather, in the region where the rope is clamped, the rope lies substantially along a circular line on the wall portion (see for example FIG. 9). Thus, the rope paths which form the sets of rope paths are to be selected in such a way that they optimally describe the path of the rope into the transport portions when a rope is to be clamped.

The ribs 110 guide a rope which is loaded in direction W towards the inside, where a clamping region 114 (indicated by a dashed schematic boundary on the first wall portion 116) of the rope pulley may be formed. The clamping region 114 may result from the first wall portion 116 and the second wall portion 118 of the clamping device being arranged in such a way that the distance between them is reduced at least in portions, resulting in them delimiting the tapering, preferably V-shaped clamping region 114 of the clamping device 102 in the form of a rope pulley. A drum 123 of the rope pulley 102, through which the rotation axle 112 of the rope pulley 102 extends, deflects the rope in the form of a rope deflection portion. In the clamping devices 102 and 102′ according to the invention, the rope clamping devices extend transversely to the first and/or second axial movement direction. Analogously to the first embodiment, in the clamping region 114 a base region BA1 indicated by a dashed line may be provided, which preferably has a width d1 of approximately 2 mm or more. Likewise, the clamping region 114 may be delimited by rib-free wall portions; this can be achieved for example by modifying e.g. two rope pulleys 104′ in such a way that the rib portions 110′a, 122′a, projecting in the dashed circle, of the ribs 110′, 122′ are removed, and these modified rope pulley halves are combined to form a rope pulley. The portions of the surface configuration within the dashed circle are free of ribs and delimit a tapering clamping region of the rope pulley over the entire extension thereof. The base region BA 1 and the wall portions which are free of ribs can be provided in combination with one another. Generally, as shown in FIG. 6c, a base portion BA2 in a rope pulley 102′ can be formed by a plane substantially parallel to the rope pulley axis, which is inserted into a V-shaped clamping region. As a result, rope wear can be reduced, in addition to the above-described advantages.

Preferably, the transport elements 110, in particular the contact portions thereof, extend into the clamping region 114 at least in part, and so the rope is reliably guided into the clamping region 114 and the clamping of the rope can be assisted by the rib and transport elements 110 or the contact portions thereof.

The ribs 122 of the transport portion F take on a function corresponding to the ribs 110 of the transport portion E when the rope is loaded in direction Z, and they (or the contact portions thereof) are preferably at a constant crossing angle A3′ (compare tangents T1′ and T2′) having a positive sign of approximately 45° to the circles concentric about the rotation axle 112.

If two rope pulley halves provided with transport portions E, F, for example two rope pulley halves 104, 106, are combined to form a rope pulley 102, it is thus preferred for cooperating transport portions, in other words transport portions leading to the same clamping region portion, to be opposite the transport portions over large portions. Preferably, this condition is met over the entire transport portions, and in particular the individual transport elements of the each transport portion, in this case ribs, are positioned opposite the rope pulley halves 104, 106; see FIG. 3d.

Transport portions which are directly adjacent in the axial rope movement direction, such as the transport portions E and F in FIG. 3a, are preferably separated by a boundary portion 124, in particular a boundary line 126. The transport portions E and F, which are directly adjacent in the axial rope movement direction, form a pair of transport portions.

Whilst in FIG. 3a the ribs converge until the boundary line, the ribs may be separated from one another by a rib-free region, for example 128 or 130, as for example in the rope pulley half 105 shown in FIGS. 6a and 6b, these boundary portions being indicated by lines G1 to G4.

The reason for a geometric separation of this type is that the inventor has found that it is advantageous if there is an angle B1 between 60° and 90°, preferably an angle between 75° and 85°, more preferably between 82° and 83°, between the direction Q, in which the rope is pulled, and the boundary portion 124 (indicated by the boundary line 126 in FIG. 9) when the rope is clamped. This feature is used in particular in safety devices 300 (of a design of a handling device for a rope) having a clamping element according to the invention in the form of a rope pulley, in which the rope pulley can be locked by a centrifugal clutch in a position predetermined for each rotation direction of the rope pulley or in a number of positions corresponding to boundary portions and predetermined for each rotation direction of the rope pulley. If the rope pulley is locked in one of the predetermined positions in the safety device, the desired angle B1 is present between the direction Q and the boundary portion. FIG. 9 shows a clamped state of a particularly thick rope, and so the clamping can take place a long way away from the rope pulley centre. The thinner the rope, the further into the rope pulley, and thus the further into a clamping region of the rope pulley, the rope can be clamped.

As is shown in FIGS. 5a and 5b, the number of ribs in a transport portion of the rope pulley half 104′ which lead into the clamping region 114′ may be less than the total number of ribs used in the transport portion. As a result, in a region outside the clamping region 114′, in which the rope is usually in contact with the surface configuration over a greater length than in the clamping region 114′, a high number of ribs can be provided in order to guide the rope reliably close to the clamping region. A high density of ribs in the clamping region would approximate a smooth surface, and so the rope could not extend sufficiently between the individual ribs, reducing the clamping effect. Therefore, ribs 132 which do not extend into the clamping region 114′ are inserted between the ribs 110′ which do extend into the clamping region 114′. The same applies to the ribs 134 which have been inserted between the ribs 122′. Each of the ribs 110′ and 132 or the contact portions thereof are at a constant crossing angle of approximately 45° to circles concentric about a rotation axle 112′; the same applies to each of the ribs 122′ and 134. Starting from the rope pulley half 104, the rope pulley halves 104′ may be formed such that the ribs 132 are inserted into the transport portion E and the ribs 134 are inserted into the transport portion E.

Each of the ribs 134″ of the rope pulley half 108 or the contact portions thereof are at a constant crossing angle of approximately 45° to circles concentric about a rotation axle 112″, since the form and arrangement of the ribs 134″ form a continuation of the arrangement of the ribs 134 of FIG. 5a about the entire circumference of the rope pulley 108.

For improved clarity, however, the concentric circles of the angles have not be shown in the drawings for the rope pulley halves 104′ and 108.

FIGS. 6a and 6b show a further embodiment of a rope pulley half of a clamping device in accordance with the first aspect of the invention, but in which four transport portions H, I, J and K are arranged. In each case, two transport portions which are directly adjacent in the axial rope movement direction, in other words separated merely by a separating region or a separating line (in this case indicated by lines G1 to G4), form a pair of transport portions, comprising a first transport portion, for example transport portion H, which is set up to guide the rope towards a first clamping region portion 136 of a clamping region in the event of movement in the direction W1, and a transport portion I which is directly adjacent in the axial rope movement direction, and which is set up to guide the rope into a second clamping region portion 138 of the clamping region of the clamping device in the event of movement in the direction Z1 (the clamping region portions being indicated by the delimitations thereof on the surface configuration consisting of a dashed circular line and the lines G4 and G1 or G1 and G2; the clamping region analogously being indicated by the dashed circular line), the directions W1 and Z1, like the directions W and Z in FIG. 3a, being orientated counter to one another along a rope path (for example circular line). It should also be noted that every two transport portions which are adjacent in the axial rope movement direction, in other words the transport portions H, I or I, J or J, K or K, H, may form a pair of transport portions in each case. As a result of arranging a plurality of transport portion pairs, optimum positioning of a boundary region (indicated by lines G1 to G4) in a safety appliance can be provided, and so a particularly favourable clamping effect is provided after a rotation through a shorter range than if only a single transport portion pair were present. In the transport portions H, I, J and K, a rope can be guided into respective clamping region portions of the clamping region by respective transport elements, for example ribs 140, 142, 144 and 146.

Although the clamping device of the above-described embodiment has been shown as a rope pulley which can rotate or can merely he pivoted through a particular angle range, the clamping device can be applied to a rotation and/or pivot element, such as an elliptical rope clamping body, of which one half 204 having transport elements 206 is shown in FIG. 7.

For simplicity, the above-described embodiments were primarily described as having transport elements in the form of ribs within the transport portions. However, the invention is not limited to ribs as transport elements; rather, the portions of the transport elements may be in the form of structures projecting from a wall portion and/or as structures projecting into a wall portion in portions. In FIG. 8, various shapes of structures of this type are formed, these being considered as structures which project in or out depending on the orientation. Thus, the structure according to FIG. 8 a) may be in the form of a semi-circular elevation or depression, or, according to FIG. 8 b), in the form of a substantially box-shaped elevation or depression. Likewise, a symmetrical tooth elevation or tooth depression according to FIG. 8 c) is conceivable as a transport element or portion thereof, an asymmetrical triangular elevation or depression according to FIG. 8 d) also being possible. Likewise, it is possible for a transport element to have a combination of a plurality of projection or recess structures in one portion, as is shown in FIG. 8 e).

In a clamping device in the form of a rope pulley, as soon as the rope comes into contact with the first and the second wall portion, this may be referred to as an initial entry of the rope into the clamping device; when the rope finally loses contact, this may be referred to as the final exit of the rope from the rope pulley. This is always considered in relation to a tautly tensioned rope, and so any slackening of the rope is not taken into account here.

The directions W and Z or W1 and Z1 may be understood as indicating a clockwise and anti-clockwise axial movement direction in the associated drawings.

The rope pulley halves 104, 104, 105, 106 and the half 204 of a rope clamping body have a surface configuration in accordance with the first aspect of the invention. The rope pulley halves 104, 104′, 106 and 108 have a surface configuration in accordance with the second aspect of the invention. Accordingly, in the above description, differences between the relevant variants are discussed in particular.

Even if the rope pulleys or rope clamping bodies have been described as being composed of two separate halves, they may be produced in a single piece, the above-described halves being understood to be parts of a single-piece rope pulley or a single-piece rope clamping body.

To maintain clarity in the drawings, instead of providing each individual transport element or each individual rib (or the portions thereof) with a reference numeral, only some individual transport elements or ribs (or portions thereof) have been provided with a reference numeral.

1.-15. (canceled)

16. A clamping device (2; 102; 102′) for a rope, comprising:
a first wall portion (4; 116); and,
a second wall portion (6; 118) opposite to the first wall portion (4; 116); wherein the first wall portion (4; 116) has a surface configuration which is
configured to move the rope in a first axial rope movement direction into a clamping area (14; 114) of the clamping device (2; 102; 102′) in case of a movement within the clamping device (2; 102; 102′), and
configured to move the rope in a second axial rope movement direction opposite to the first axial rope movement direction into the clamping area (14; 114) of the clamping device (2; 102; 102′) in case of a movement within the clamping device (2; 102; 102′).

17. The clamping device of claim 16, wherein the first wall portion (4; 116) has a surface configuration which has a transport element (20, 22; 110, 122; 110′, 122′, 132, 134), the rope and a contact portion of the transport element (20, 22; 110, 122; 110′, 122′, 132, 134), when the rope is laid in the clamping device (2; 102; 102′) as in normal operation, being at a crossing angle (A1, A2; A3) which is in an angle range between 15° and 75°.

18. The clamping device of claim 16, wherein the first wall portion (4; 116) has a surface configuration which has a transport element (20, 22; 110, 122; 110′, 122′, 132, 134), the rope and a contact portion of the transport element (20, 22; 110, 122; 110′, 122′, 132, 134), when the rope is laid in the clamping device (2; 102; 102′) as in normal operation, being at a crossing angle (A1, A2; A3) which is in an angle range between 30° and 60°.

19. The clamping device of claim 16, wherein the first wall portion (4; 116) has a surface configuration which has a transport element (20, 22; 110, 122; 110′, 122′, 132, 134), the rope and a contact portion of the transport element (20, 22; 110, 122; 110′, 122′, 132, 134), when the rope is laid in the clamping device (2; 102; 102′) as in normal operation, being at a crossing angle (A1, A2; A3) which is an angle of approximately 45°.

20. The clamping device of claim 16, wherein an axial rope movement direction is transverse to a rope clamping direction when the rope is laid in the clamping device (2; 102; 102′) as in normal operation.

21. The clamping device of claim 16, wherein the surface configuration has at least one transport element (20, 22; 110, 122; 110′, 122′) which is formed as a rib and preferably projects into a clamping region (14; 114).

22. The clamping device of claim 16, wherein the surface configuration has a pair of transport portions comprising:
a first transport portion (A; E) which is configured to move the rope into a first clamping region portion (10, 136) of the clamping device (2; 102; 102′) in the event of movement within the clamping device (2; 102; 102′) in a first axial rope movement direction; and,
a second transport portion (B; F) which is configured to move the rope into a second clamping region portion (12; 138) of the clamping device (2; 102; 102′) in the event of movement within the clamping device (2; 102; 102′) in a second axial rope movement direction counter to the first axial rope movement direction.

23. The clamping device of claim 22, wherein the first transport portion (A; E) is directly adjacent to the second transport portion (B; F) in the axial rope movement direction.

24. The clamping device of claim 16, wherein the clamping device (102; 102′) is in the form of a pivot element, a rotation element, or a rope pulley.

25. The clamping device of claim 24, wherein the clamping device (102; 102′) has a rope deflection portion (123), and in particular a pivot or rotation axle (112) of the clamping device (102; 102′) passes through the rope deflection portion (123).

26. The clamping device of claim 16, wherein the first wall portion (4; 116) and the second wall portion (6, 118) are arranged in such a way that they delimit a tapering clamping region of the clamping device (2; 102; 102′).

27. The clamping device of claim 26, wherein the tapering clamping region has a base portion (BA; BA1; BA2).

28. The clamping device of claim 26, wherein wall sub-portions of the first wall portion (4; 116) and of the second wall portion (6, 118) which delimit the tapering clamping region over the entire extension thereof are formed free of ribs.

29. The clamping device of claim 27, wherein wall sub-portions of the first wall portion (4; 116) and of the second wall portion (6, 118) which delimit the tapering clamping region over the entire extension thereof are formed free of ribs.

30. The clamping device of claim 16, wherein the clamping device (2; 102; 102′) is configured to bring the rope into a clamping state without a relative movement of elements of the clamping device (2; 102; 102′).

31. The clamping device of claim 16, wherein, when the rope is laid in the clamping device (2; 102; 102′) as in normal operation, in a clamping state the rope is constantly in contact with the first wall portion and preferably with the second wall portion between the initial entry of the rope into the clamping device and the final exit thereof from the clamping device (2; 102; 102′).

32. A handling device (300) for a rope, in particular a safety device (300) for a rope, comprising the clamping device (102; 102′) of claim 16.

33. A handling device (300) for a rope, comprising the clamping device (102; 102′) of claim 22, wherein the first transport portion (E) is separated from the second transport portion (F) by a boundary portion (124, 126) and wherein, in a state where the rope is clamped in the clamping device (102; 102′), the boundary portion (124, 126) and a rope pull direction (Q) are at an angle (B1) between 90° and 60°.

34. A handling device (300) for a rope, comprising the clamping device (102; 102′) of claim 22, wherein the first transport portion (E) is separated from the second transport portion (F) by a boundary portion (124, 126) and wherein, in a state where the rope is clamped in the clamping device (102; 102′), the boundary portion (124, 126) and a rope pull direction (Q) are at an angle (B1) between 85° and 75°.

35. A handling device (300) for a rope, comprising the clamping device (102; 102′) of claim 22, wherein the first transport portion (E) is separated from the second transport portion (F) by a boundary portion (124, 126) and wherein, in a state where the rope is clamped in the clamping device (102; 102′), the boundary portion (124, 126) and a rope pull direction (Q) are at an angle (B1) between 83° and 82°.
